(19) United States
(12) Patent Application Publication
(10) Pub. No.: US 2020/0131838 A1
(43) Pub. Date: Apr. 30, 2020

(54) DRIVE UNIT

(71) Applicants: MITSUBA Corporation, Gunma (JP); Honda Motor Co.,Ltd., Tokyo (JP)

(72) Inventors: Yoshitaka URANO, Gunma (JP); Joji GOTO, Saitama (JP); Kenichiro KAGAWA, Saitama (JP); Takashi FUKAHORI, Saitama (JP); Hiroshi SHINGU, Saitama (JP)

(73) Assignees: MITSUBA Corporation, Gunma (JP); Honda Motor Co.,Ltd., Tokyo (JP)

(21) Appl. No.: 16/663,364

(22) Filed: Oct. 25, 2019

(30) Foreign Application Priority Data
Oct. 26, 2018 (JP) 2018-201485

(51) Int. Cl. E05F 15/646; B66D 1/22; B66D 1/12

(52) U.S. Cl. CPC E05F 15/646; B66D 1/22; B66D 1/12; E05Y 2900/531; E05Y 2201/654; E05Y 2201/664; E05Y 2201/216

(57) ABSTRACT

A drive unit is configured such that a closing side drum and an opening side drum are provided parallel to each other. In a state in which a closing side cable is wound around a small diameter portion of the closing side drum and an opening side cable is wound around a small diameter portion of the opening side drum, the sliding door moves from a predetermined position relative to an opening portion to a position where the opening portion is fully closed, and, in the state in which the closing side cable is wound around a large diameter portion of the closing side drum and the opening side cable is wound around a large diameter portion of the opening side drum, the sliding door moves from the predetermined position relative to the opening portion to a position where the opening portion is fully open.

### CROSS-REFERENCE TO RELATED APPLICATION

This application claims the priority benefit of Japan Application No. 2018-201485, filed on Oct. 26, 2018. The entirety of the above-mentioned patent application is hereby incorporated by reference herein and made a part of this specification.

### BACKGROUND

### Technical Field

The present disclosure relates to a drive unit which drives an opening and closing body for opening and closing an opening portion.

### Description of Related Art

At a side portion of a vehicle such as a minivan, an opening portion is provided for a passenger to get on and off and to take in and out luggage. The opening portion opens to a relatively large extent and is opened and closed by a sliding door including a roller assembly. Since the sliding door is heavy, a sliding door opening and closing mechanism that can automatically open and close the sliding door may be mounted on a vehicle including a sliding door.

The sliding door opening and closing mechanism includes a drive unit. The drive unit is provided with a closing side cable and an opening side cable for pulling the sliding door in a closing direction and an opening direction, respectively. The drive unit includes drums around which the closing side cable and the opening side cable are wound in directions opposite to each other, and the drums rotate forward or in reverse to drive the closing side cable or the opening side cable, thereby opening and closing the sliding door.

Such a drive unit is disclosed, for example, in Specification of Patent Document 1 (U.S. Pat. No. 7,025,298). The drive unit disclosed in Specification of Patent Document 1 includes an electric motor and a pair of drums rotated by the electric motor. In addition, end portions of the pair of cables are wound around the pair of drums in directions opposite to each other, and, when one cable is wound in, the other cable is released therefrom.

Further, a small diameter portion is formed on one of the drums, and by winding one of the cables on the small diameter portion, a large pulling force is generated in the one of the cables, whereby the sliding door can be locked in a fully closed state. That is, the drive unit disclosed in Patent Document 1 is provided with a so-called door closer function that locks the sliding door in the fully closed state.

However, in the drive unit disclosed in Specification of U.S. Pat. No. 7,025,298 described above, the pair of drums respectively corresponding to the pair of cables are provided to coaxially overlap each other. In addition, a tension spring is provided between the pair of drums to absorb slack in a cable (a change in cable length) when one of the cables is wound around the small diameter portion of one of the drums.

Therefore, a problem may occur in that a thickness dimension of the drive unit in an axial direction of the drum becomes thicker, and thus it becomes difficult to mount it on a small vehicle or the like having a limited mounting space. In addition, a problem may also occur in that the tension spring which is operated during the door closer function being performed is provided between the pair of drums, and thus the number of components and the weight increase.

### SUMMARY

It is a purpose of the present disclosure to provide a drive unit that can achieve reduction in size and weight while including a door closer function.

One aspect of the present disclosure is a drive unit which drives an opening and closing body for opening and closing an opening portion, including a first axle and a second axle which are provided parallel to each other, a first drum which is rotatably provided on the first axle and has a small diameter portion on one side in an axial direction thereof and a large diameter portion on the other side in the axial direction, a second drum which is rotatably provided on the second axle and has a large diameter portion on one side in an axial direction thereof and a small diameter portion on the other side in the axial direction, a first cable which pulls the opening and closing body in a closing direction, a second cable which pulls the opening and closing body in an opening direction, an electric motor which is provided coaxially with the first axle and drives the first drum, and a power transmission member which is provided between the first drum and the second drum and transmits a driving force of the first drum to the second drum, in which, in a state in which the first cable is wound around the small diameter portion of the first drum and the second cable is wound around the small diameter portion of the second drum, the opening and closing body moves from a predetermined position relative to the opening portion to a position where the opening portion is fully closed, and, in a state in which the first cable is wound around the large diameter portion of the first drum and the second cable is wound around the large diameter portion of the second drum, the opening and closing body moves from the predetermined position relative to the opening portion to a position where the opening portion is fully open.

In another aspect of the present disclosure, a reduction mechanism is provided between the electric motor and the first drum, and the reduction mechanism reduces a rotational speed of the electric motor to increase a rotational torque of the first drum.

According to the present disclosure, the first drum and the second drum are provided parallel to each other, the first drum is driven by the electric motor, and the driving force of the first drum is transmitted to the second drum by the power transmission member. In addition, in the state in which the first cable is wound around the small diameter portion of the first drum and the second cable is wound around the small diameter portion of the second drum, the opening and closing body moves from the predetermined position relative to the opening portion to the position where the opening portion is fully closed, and, in the state in which the first cable is wound around the large diameter portion of the first drum and the second cable is wound around the large diameter portion of the second drum, the opening and closing body moves from the predetermined position relative to the opening portion to the position where the opening portion is fully open.

As a result, an increase in thickness dimension of the drive unit in the axial direction of the drums can be inhibited. In addition, it is possible to absorb a cable slack (a change in cable length) while allowing the drive unit to have a door closer function. Further, since the electric motor is provided coaxially with the first drum required to be driven with a high torque, a driving torque of the electric motor can be efficiently transmitted to the first drum.

### BRIEF DESCRIPTION OF THE DRAWINGS

FIG. 1 is a side view of a vehicle provided with a drive unit according to the present disclosure.

FIG. 2 is a plan view illustrating a structure for attaching a sliding door to a vehicle body.

FIG. 3 is a perspective view of the drive unit (with a gear cover not shown) of FIG. 2 when viewed in a direction of arrow A.

FIG. 4 is a cross-sectional view (with the gear cover shown) taken along line B-B of FIG. 3.

FIG. 5 is a cross-sectional view (with the gear cover shown) taken along line C-C of FIG. 3.

FIGS. 6(a) and 6(b) are perspective views illustrating a closing side drum, an opening side drum, and a drive belt.

FIG. 7 is a side view illustrating cable grooves of the closing side drum.

FIG. 8 is a side view illustrating cable grooves of the opening side drum.

FIG. 9(a) is a view showing a “fully open state” in which an opening side cable is wound around the opening side drum, and FIG. 9(b) is a view showing a “fully closed state” in which a closing side cable is wound around the closing side drum.

FIG. 10 is an explanatory view illustrating a change in length of the cables.

FIG. 11 is a graph illustrating a change in length of the cables.

FIG. 12 is a graph illustrating a door closer function.

### DESCRIPTION OF EMBODIMENTS

Hereinafter, one embodiment of the present disclosure will be described in detail with reference to the drawings.

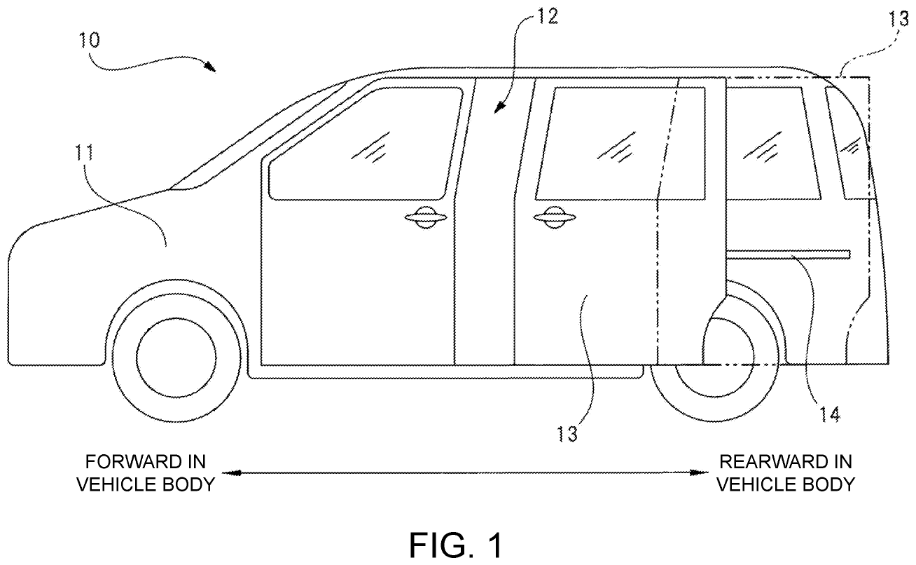

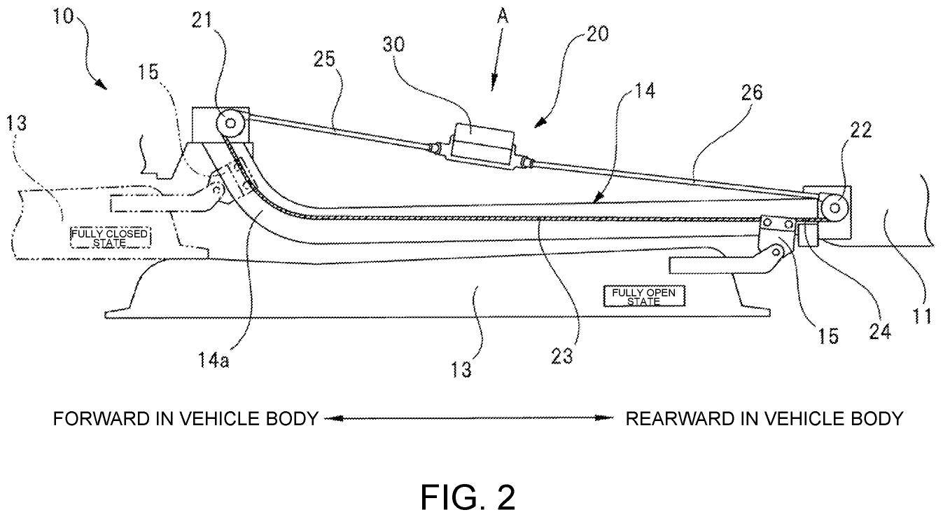

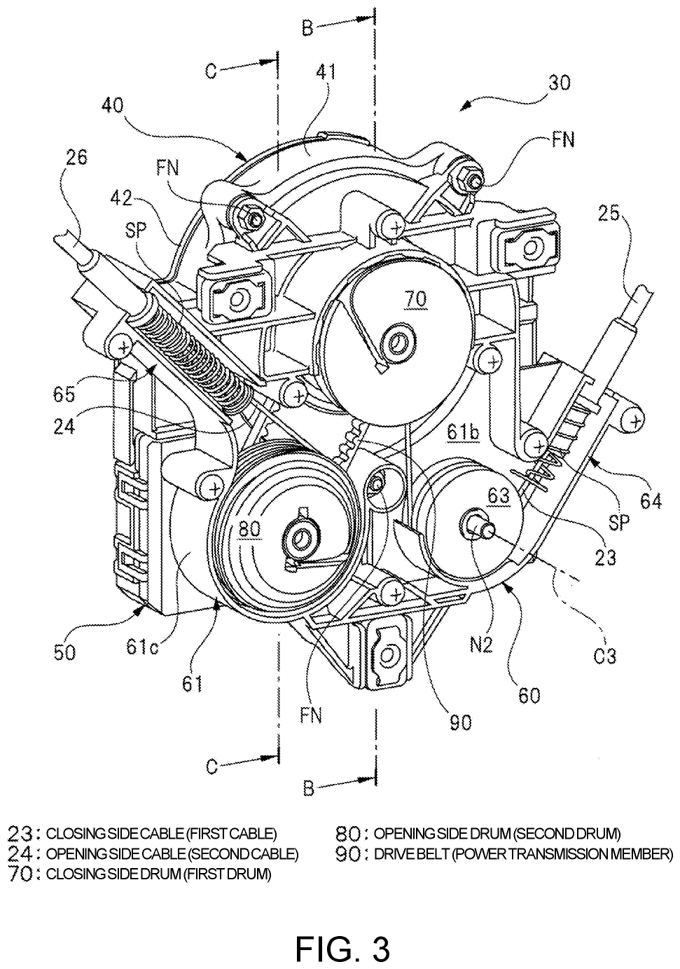

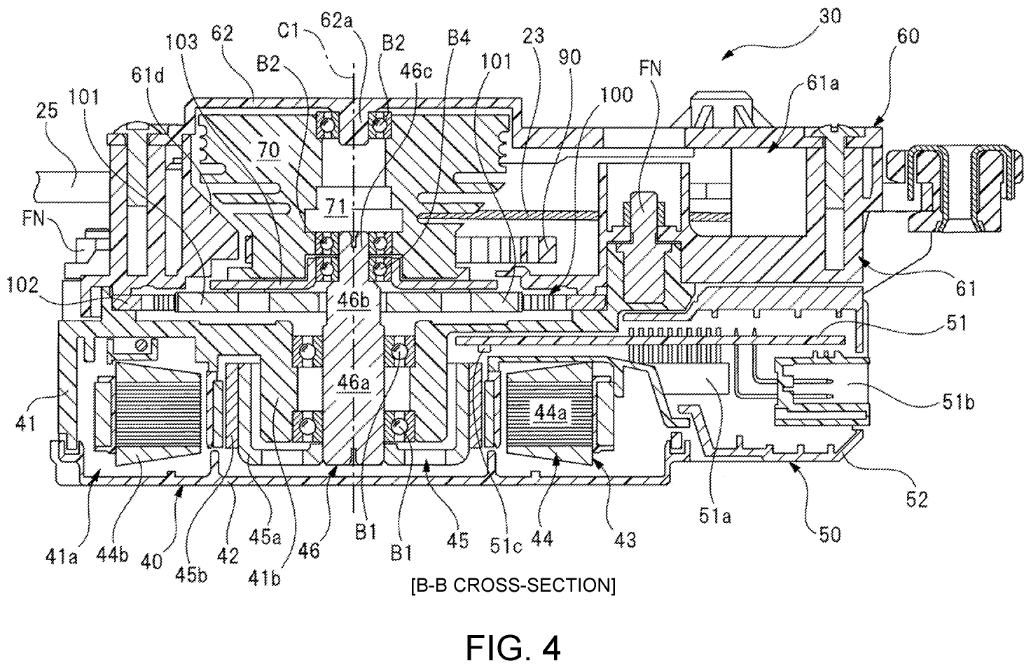

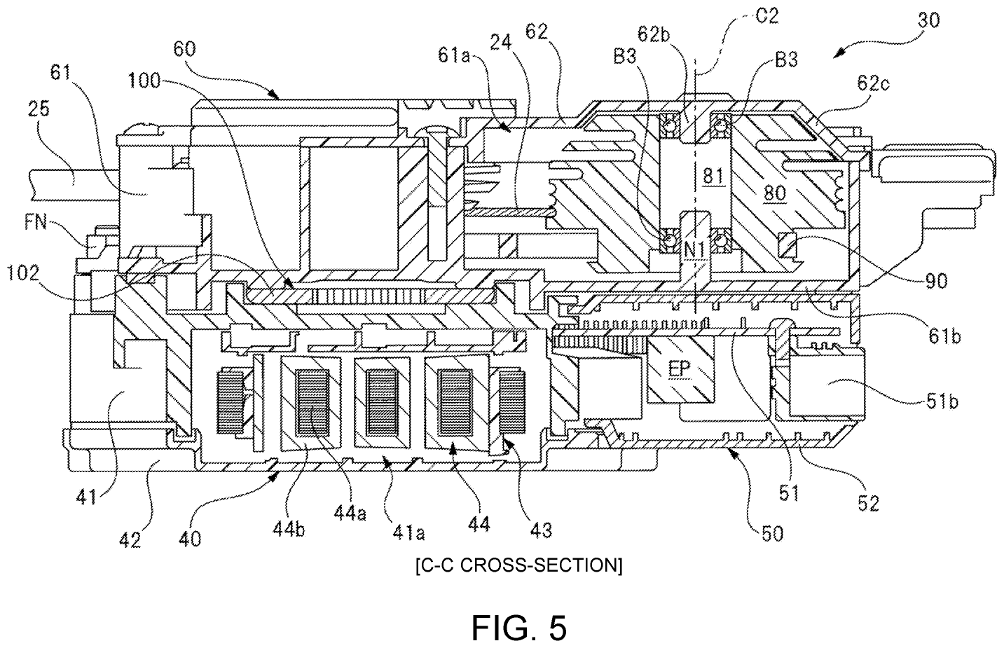

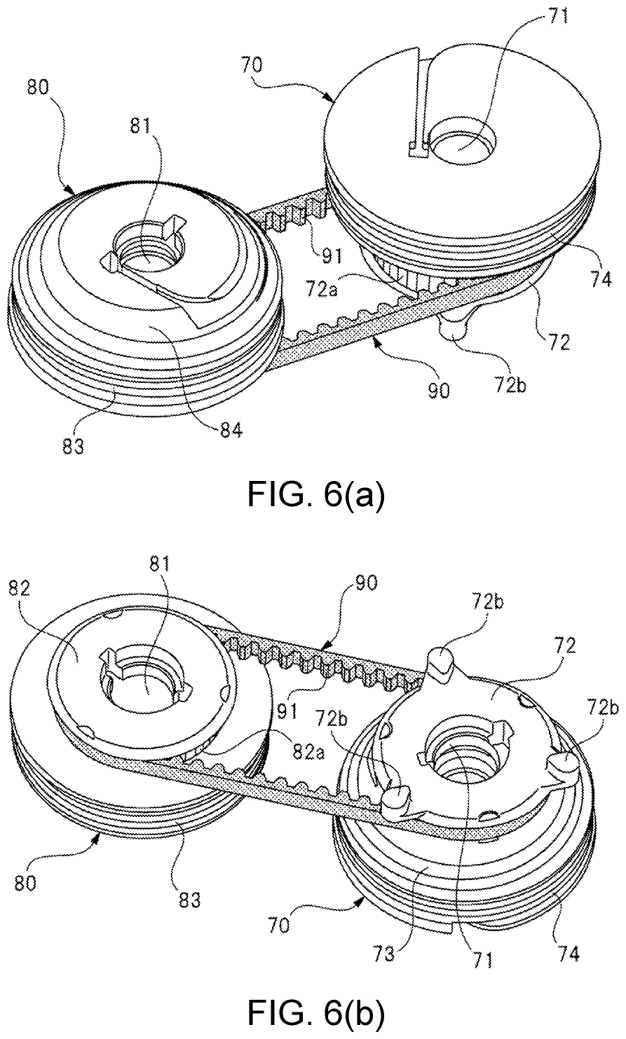

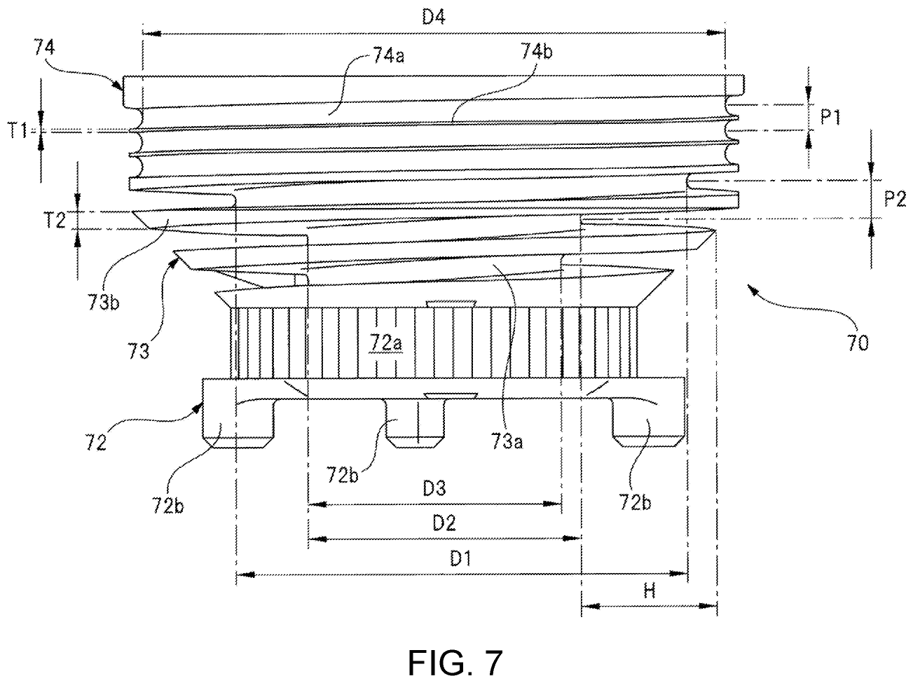

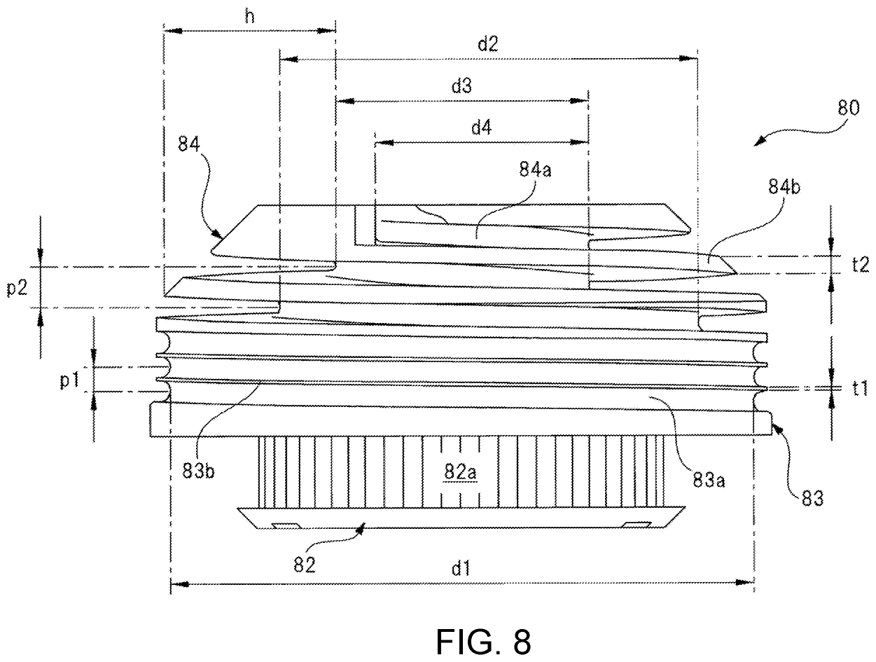

FIG. 1 is a side view of a vehicle provided with a drive unit according to the present disclosure, FIG. 2 is a plan view illustrating a structure for attaching a sliding door to a vehicle body, FIG. 3 is a perspective view of the drive unit (with a gear cover not shown) of FIG. 2 when viewed in a direction of arrow A, FIG. 4 is a cross-sectional view (with the gear cover shown) taken along line B-B of FIG. 3, FIG. 5 is a cross-sectional view (with the gear cover shown) taken along line C-C of FIG. 3, FIGS. 6(a) and 6(b) are perspective views illustrating a closing side drum, an opening side drum, and a drive belt, FIG. 7 is a side view illustrating cable grooves of the closing side drum, and FIG. 8 is a side view illustrating cable grooves of the opening side drum.

A vehicle 10 shown in FIG. 1 is, for example, a wagon type vehicle capable of carrying eight people, and a relatively large opening portion 12 is provided on a side portion of a vehicle body 11 of the vehicle 10. The opening portion 12 is opened and closed by a sliding door (an opening and closing body) 13 provided movably in the vehicle body 11. The sliding door 13 is guided by a guide rail 14 fixed to the side portion of the vehicle body 11, and moves in a longitudinal direction of the vehicle body 11 between a fully closed position and a fully open position. In addition, by moving the sliding door 13 to the fully open position (a two-dot dashed line in the figure), the opening portion 12 is opened to a large extent, and thus a passenger can easily get on and off, luggage can be easily loaded in and out, and the like.

As shown in FIG. 2, a roller assembly 15 is provided on a rear side of the sliding door 13 in the vehicle body and at a center portion of the sliding door 13 in the vertical direction. The roller assembly 15 moves on the guide rail 14 along a shape of the guide rail 14, and thus the sliding door 13 moves in the longitudinal direction of the vehicle body 11 along the side portion of the vehicle body 11.

A curved portion 14a that is curved toward the inside of a passenger compartment (upward in the figure) is provided on a front side of the guide rail 14 in the vehicle body. Also, when the roller assembly 15 moves forward in the vehicle body and passes through the position of the curved portion 14a, the sliding door 13 is pulled inward in vehicle body 11 to be in a “fully closed state,” as indicated by a two-dot dashed line in the figure, thereby being substantially flush with a side surface of the vehicle body 11.

Further, in addition to the roller assembly 15, roller assemblies (not shown) are also provided on the front side and at upper and lower portions of the sliding door 13 in the vehicle body. Moreover, guide rails (not shown) are also provided at upper and lower portions of the opening portion 12 of the vehicle body 11 to respectively correspond to the roller assemblies on the upper and lower portions of the sliding door 13. That is, the sliding door 13 is supported on the vehicle body 11 at a total of three places, and thus it is possible to perform stable opening and closing operations with respect to the vehicle body 11.

As shown in FIG. 2, a sliding door opening and closing mechanism 20 for automatically opening and closing the sliding door 13 is provided at the side portion of the vehicle body 11 of the vehicle 10. The sliding door opening and closing mechanism 20 includes a drive unit 30, and the drive unit 30 is fixed to a vehicle body panel (not shown) forming the vehicle body 11 to be adjacent to a central portion of the guide rail 14 in a longitudinal direction thereof.

The sliding door opening and closing mechanism 20 includes a pair of reversing pulleys 21 and 22 disposed respectively on both sides of the guide rail 14 in the longitudinal direction, a closing side cable (a first cable) 23 which pulls the sliding door 13 in a closing direction (forward in the vehicle body), and an opening side cable (a second cable) 24 which pulls the sliding door 13 in an opening direction (rearward in the vehicle body).

In addition, one sides of the closing side cable 23 and the opening side cable 24 in the longitudinal direction are guided to the inside of the drive unit 30. On the other hand, the other sides of the closing side cable 23 and the opening side cable 24 in the longitudinal direction are connected to the roller assembly 15 from the front and from the rear of the vehicle body via the pair of reversing pulleys 21 and 22, respectively.

As a result, when the drive unit 30 is driven forward, the closing side cable 23 is pulled to move the sliding door 13 in the closing direction. On the other hand, when the drive unit 30 is driven in reverse, the opening side cable 24 is pulled to drive the sliding door 13 in the opening direction. That is, the drive unit 30 is configured to open and close the sliding door 13.

Also, portions of a pair of cables 23 and 24 disposed outside the vehicle body 11 are hidden by a guide groove (not shown) provided inside the guide rail 14. Thus, the pair of cables 23 and 24 are not exposed to the outside. Therefore, the pair of cables 23 and 24 can be protected from rain water, dust and the like while improving the appearance of the vehicle 10.

Further, outer casings 25 and 26 which cover circumferences of the pair of cables 23 and 24 and slidably hold the pair of cables 23 and 24 are provided between the pair of reversing pulleys 21 and 22 and the drive unit 30, respectively. The outer casings 25 and 26 have flexibility, and a sliding grease (not shown) is applied to the inside thereof. Thus, the pair of cables 23 and 24 can be protected, and the pair of cables 23 and 24 can slide smoothly relative to the pair of outer casings 25 and 26.

As shown in FIGS. 3 to 5, the drive unit 30 includes a motor section 40, a board accommodating section 50, and a drum accommodating section 60, and these are formed integrally with one another using a plurality of fastening members FN (only three shown in the figures). Also, among the motor section 40, the board accommodating section 50, and the drum accommodating section 60, the drum accommodating section 60 is the largest section.

When the drum accommodating section 60 is viewed in an axial direction of a rotation shaft 46, the motor section 40 and the board accommodating section 50 are located substantially within a range where the drum accommodating section 60 projects.

As described above, the motor section 40 and the board accommodating section 50 are substantially located with the range where the drum accommodating section 60 projects, and the motor section 40 and the board accommodating section 50 are arranged in a direction orthogonal to the axial direction of the rotation shaft 46, thereby inhibiting an increase in dimension of the thickness of the rotation shaft 46 of the drive unit 30 in the axial direction.

The motor section 40 includes a motor housing 41 made of a resin material such as plastic, and a flat plate-shaped motor cover 42 closing an opening portion 41a of the motor housing 41. In addition, the motor cover 42 is also formed of a resin material such as plastic, and thus reduction in weight of the motor section 40 is achieved.

The motor housing 41 is formed in a flat, substantially cylindrical shape, and a flat brushless motor (an electric motor) 43 is accommodated therein. The brushless motor 43 includes a stator 44 formed in an annular shape, and a rotor 45 which rotates inside the stator 44 in a radial direction thereof.

The stator 44 is firmly fixed to the motor housing 41 using a fixing screw or the like (not shown). The stator 44 includes a stator core 44a formed by laminating a plurality of steel plates (not shown) made of a magnetic material. A plurality of teeth (not shown) around which U-phase, V-phase, and W-phase coils 44b are wound with a predetermined number of windings and a method of winding are provided inside the stator core 44a in the radial direction.

The rotor 45 includes a rotor main body 45a having a substantially U-shaped cross-section. The rotor main body 45a is formed by pressing a steel plate or the like, and a plurality of permanent magnets 45b are fixed outside the rotor main body 45a in the radial direction to be aligned side by side in a circumferential direction thereof. On the other hand, a base end portion of the rotation shaft 46 in the axial direction, which is made of a cylindrical steel rod, is fixed inside of the rotor main body 45a in the radial direction.

The rotation shaft 46 includes a large diameter portion 46a of which a base end portion in the axial direction is fixed to a center of the rotor main body 45a, a sun gear 46b which forms a planetary gear reducer 100, and a small diameter portion 46c which rotatably supports a closing side drum 70. Also, the rotation shaft 46 is rotatably supported by the motor housing 41.

Specifically, a boss portion 41b which is thicker than the other portions of the motor housing 41 is provided at a substantially central portion of the motor housing 41. A pair of large diameter ball bearings B1 are mounted inside the boss portion 41b in the radial direction. The large diameter portion 46a of the rotation shaft 46 is rotatably supported by the large diameter ball bearings B1. Also, the pair of large diameter ball bearings B1 are provided to be separated from each other on both sides of the boss portion 41b in the axial direction. Thus, the rotation shaft 46 can be stably rotated at high speed without swaying.

The board accommodating section 50 is provided close to the motor section 40, and a control board 51 which controls a rotating state of the brushless motor 43 is accommodated inside the board accommodating section 50. A switching element 51a which supplies a drive current to the U-phase, V-phase and W-phase coils 44b forming the brushless motor 43 one after another at high speed is mounted on the control board 51.

Also, a connector connection portion 51b to which an external connector (not shown) on the vehicle 10 side is connected is electrically connected to the control board 51. Thus, the drive current from the external connector is supplied to the drive unit 30.

Further, a plurality of Hall ICs 51c (only one is shown in FIG. 4) which detect the rotating state of the brushless motor 43 are mounted on the control board 51. Specifically, the plurality of Hall ICs 51c are disposed close to the permanent magnets 45b provided in the rotor 45. Thus, in accordance with rotation of the rotor 45, the plurality of Hall ICs 51c generate pulse signals (rectangular wave signals) at predetermined timings.

Also, a central processing unit (CPU) (not shown) to which pulse signals from the plurality of Hall ICs 51c are input is mounted on the control board 51. Thus, the CPU can ascertain the rotating state (rotating speed, rotating direction, etc.) of the rotor 45, and can control the switching element 51a optimally. Therefore, the rotating state of the brushless motor 43 is controlled with high accuracy. In addition, as shown in FIG. 5, other electronic components EP such as a capacitor are also mounted on the control board 51.

Furthermore, a part of a housing 52 forming a contour of the board accommodating section 50 (the details are not shown) is formed of an aluminum material or the like having a high thermal conductivity. Thus, the heat of the switching element 51a which is in a high temperature state during the brushless motor 43 being operated can be dissipated quickly to the outside.

The drum accommodating section 60 includes a drum housing 61 made of a resin material such as plastic, and a flat plate-shaped drum cover 62 which closes an opening portion 61a of the drum housing 61. Also, the drum cover 62 is also made of a resin material such as plastic, and thus reduction in weight of the drum accommodating section 60 is achieved.

The drum housing 61 is formed in a flat and substantially potbellied shape, and includes a bottom wall portion 61b and a side wall portion 61c provided upright around the bottom wall portion 61b. In addition, the closing side drum 70, an opening side drum 80 and a direction changing pulley 63 are rotatably accommodated inside the drum housing 61. Here, the closing side drum 70, the opening side drum 80 and the direction changing pulley 63 are all formed of a resin material such as plastic, and thus reduction in weight of the drive unit 30 is achieved while a value of each moment of inertia is reduced.

The closing side drum 70 is provided coaxially with the rotation shaft 46 of the motor section 40, and is disposed at a substantially central portion of the drum housing 61 and at a portion near the motor section 40. In addition, the closing side cable 23 which pulls the sliding door 13 (see FIG. 2) in the closing direction is wound around the closing side drum 70.

Also, the opening side drum 80 is provided side by side with the direction changing pulley 63 at a portion near the board accommodating section 50 of the drum housing 61. In addition, an axis C1 (see FIG. 4) of the closing side drum 70, an axis C2 (see FIG. 5) of the opening side drum 80, and an axis C3 (see FIG. 3) of the direction changing pulley 63 are parallel to each other, and lines connecting these axes C1, C2 and C3 form a substantially regular triangle. Further, the opening side cable 24 which pulls the sliding door 13 in the opening direction is wound around the opening side drum 80.

As shown in FIG. 4, a through hole 71 axially penetrating the closing side drum 70 is provided at a rotational center of the closing side drum 70, and a pair of small diameter ball bearings B2 are mounted on both sides of the through hole 71 in the axial direction. In addition, the small diameter ball bearing B2 on one side (the motor section 40 side) of the closing side drum 70 in the axial direction is mounted on the small diameter portion 46c of the rotation shaft 46. On the other hand, the small diameter ball bearing B2 on the other side (a side opposite to the motor section 40 side) of the closing side drum 70 in the axial direction is mounted on a first support protruding portion 62a integrally provided inside the drum cover 62. Thus, the closing side drum 70 can be smoothly rotated about the axis C1.

Here, the small diameter portion 46c centered on the axis C1 and the first support protruding portion 62a centered on the axis C1 constitute a first axle in the present disclosure. That is, the closing side drum 70 is rotatably provided on the small diameter portion 46c and the first support protruding portion 62a.

As shown in FIG. 5, a through hole 81 penetrating the opening side drum 80 in the axial direction is provided on a rotational center of the opening side drum 80, and a pair of small diameter ball bearings B3 are mounted on both sides of the through hole 81 in the axial direction. In addition, the small diameter ball bearing B3 on one side (the motor section 40 side) of the opening side drum 80 in the axial direction is mounted on a first support pin N1 integrally provided on the bottom wall portion 61b. On the other hand, the small diameter ball bearing B3 on the other side (a side opposite to the motor section 40 side) of the closing side drum 80 in the axial direction is mounted on a second support protruding portion 62b integrally provided inside the drum cover 62. Thus, the opening side drum 80 can be smoothly rotated about the axis C2.

Here, the first support pin N1 centered on the axis C2 and the second support protruding portion 62b centered on the axis C2 constitute a second axle in the present disclosure. That is, the opening side drum 80 is rotatably provided on the first support pin N1 and the second support protruding portion 62b.

Further, as shown in FIG. 3, the direction changing pulley 63 changes a direction of the closing side cable 23 pulled into the drum housing 61 toward the closing side drum 70, and is rotatably supported by a second support pin N2 integrally provided on the bottom wall portion 61b. Also, more detailed structures of the closing side drum 70 and the opening side drum 80 and a state of arrangement thereof inside the drum housing 61 will be described in detail later.

As shown in FIG. 3, a closing side cable guide portion 64 and an opening side cable guide portion 65 are integrally provided on the side wall portion 61c forming the drum housing 61. The cable guide portions 64 and 65 have a function of guiding the closing side cable 23 and the opening side cable 24 into the drum housing 61, and are each formed in a substantially box shape. In addition, the closing side cable guide portion 64 is disposed in the vicinity of the direction changing pulley 63 and guides the closing side cable 23 toward the direction changing pulley 63 from the motor section 40 side. On the other hand, the opening side cable guide portion 65 is disposed in the vicinity of the opening side drum 80 and guides the opening side cable 24 toward the opening side drum 80 from the motor section 40 side.

Also, coil springs SP are accommodated in the pair of cable guide portions 64 and 65, respectively. The coil springs SP bias the outer casings 25 and 26 toward the outside of the drum housing 61, respectively. Thus, any slight slack in the pair of cables 23 and 24 which have stretched with the elapse of time can be absorbed outside the drum housing 61.

Here, the opening side cable 24 which pulls the sliding door 13 (see FIG. 2) in the opening direction is wound around the opening side drum 80 due to a driving force of the opening side drum 80. The driving force of the opening side drum 80 in this case is transmitted from the closing side drum 70 via a drive belt 90. Also, a detailed structure of the drive belt 90 will also be described later.

As shown in FIG. 4, the closing side drum 70 is disposed coaxially with the brushless motor 43 and is driven by the brushless motor 43 with a large rotational torque. Specifically, the planetary gear reducer (reduction mechanism) 100, which reduces a rotational speed of the rotation shaft 46 of the brushless motor 43 to increase the rotational torque of the closing side drum 70, is provided between the brushless motor 43 and the closing side drum 70.

The planetary gear reducer 100 includes a sun gear 46b integrally provided on the rotation shaft 46, three planetary gears 101 (only two are shown in the figure) which engage with the sun gear 46b and are rollably provided around the sun gear 46b, an outer gear 102 which is provided around the planetary gears 101 and engages with the planetary gears 101, and a planetary carrier 103 which holds the three planetary gears 101 and rotates in accordance with a revolving motion of the planetary gears 101.

More specifically, the outer gear 102 is formed in an annular shape, and is sandwiched between the motor housing 41 and the drum housing 61. That is, the outer gear 102 is firmly fixed non-rotatably to the housings 41 and 61. Also, the planetary carrier 103 transmits a rotating force to the closing side drum 70, and the planetary carrier 103 is integrally rotatably connected to the closing side drum 70.

In addition, a small diameter ball bearing B4 is mounted inside the planetary carrier 103 in the radial direction, and the small diameter ball bearing B4 is mounted on the small diameter portion 46c of the rotation shaft 46. Thus, the planetary carrier 103 can be smoothly rotated relative to the rotation shaft 46.

Describing operations of the planetary gear reducer 100, first, the rotation shaft 46 of the brushless motor 43 is rotated at high speed. Then, as the rotation shaft 46 rotates, the sun gear 46b is also rotated at high speed. At this time, since the outer gear 102 is fixed to the housings 41 and 61, the three planetary gears 101 revolve while rolling around the sun gear 46b. A revolving speed of the planetary gears 101 at this time is much lower than the rotating speed of the sun gear 46b. As a result, the planetary carrier 103 holding the planetary gears 101 is rotated in a state of a low speed and a high torque, and thus the closing side drum 70 is rotated with a large rotational torque.

The closing side drum 70, the opening side drum 80 and the drive belt 90 are accommodated inside the drum housing 61 in a dispositional relationship as shown in FIG. 6(a) and FIG. 6(b). Also, a lower side in FIG. 6 (a) and an upper side in FIG. 6 (b) are one side of each of the drums 70 and 80 in the axial direction and become a side facing the motor section 40. On the other hand, an upper side in FIG. 6(a) and a lower side in FIG. 6(b) are the other side of each of the drums 70 and 80 in the axial direction and become a side facing the drum cover 62.

The closing side drum 70 constitutes a first drum in the present disclosure, and forms a shape as shown in FIGS. 6(a), 6(b) and 7. The closing side drum 70 is formed in a substantially disc shape and is made of a resin material such as plastic, and the through hole 71 to which the pair of small diameter ball bearings B2 (see FIG. 4) are attached is formed at the rotational center thereof.

A closing side power transmitting portion 72 is provided at one end (a lower side in FIG. 7) of the closing side drum 70 in the axial direction. The closing side power transmitting portion 72 includes a closing side belt engaging portion 72a and three engaging claws 72b. The closing side belt engaging portion 72a includes a plurality of irregularities (the details are not shown), and rubber teeth 91 of the drive belt 90 engage with the closing side belt engaging portion 72a.

Also, the three engaging claws 72b are provided at equal intervals (120 degree intervals) in a circumferential direction of the closing side drum 70 and protrude in the axial direction of the closing side drum 70. In addition, the engaging claws 72b are configured to be hooked on the planetary carrier 103 (see FIG. 4) of the planetary gear reducer 100. Thus, a rotating force of the planetary carrier 103 is transmitted to the closing side drum 70.

A small diameter portion 73 around which the closing side cable 23 is wound is provided on one side of the closing side drum 70 in the axial direction and at a portion on the drum cover 62 side (upper side in FIG. 7) from the closing side power transmitting portion 72. Spiral-shaped small diameter cable grooves 73a are provided in the small diameter portion 73, and winding diameters of the closing side cable 23 wound around the small diameter cable grooves 73a gradually decrease to D1→D2→D3 (D1>D2>D3) toward the closing side power transmitting portion 72.

The large diameter portion 74 around which the closing side cable 23 is wound is provided on the other side (the drum cover 62 side) of the closing side drum 70 in the axial direction. The large diameter portion 74 is larger in diameter than the small diameter portion 73, and spiral-shaped large diameter cable grooves 74a are provided in the large diameter portion 74. In addition, a winding diameter of the closing side cable 23 wound around the large diameter cable grooves 74a is D4 which is constant throughout the entire region of the large diameter cable grooves 74a.

Also, the winding diameter D4 of the large diameter cable grooves 74a is larger than the winding diameter D1 of a portion having the largest diameter in the small diameter cable grooves 73a (D4>D1).

In addition, the large diameter cable grooves 74a are connected to the small diameter cable grooves 73a at a substantially central portion of the closing side drum 70 in the axial direction. That is, the large diameter cable grooves 74a and the small diameter cable grooves 73a form one continuous spiral-shaped cable groove.

An end portion of the closing side cable 23 wound around the closing side drum 70 is fixed to the other side of the closing side drum 70 in the axial direction, that is, to the large diameter portion 74 side. That is, as winding of the closing side cable 23 around the closing side drum 70 is progressed, the closing side cable 23 is gradually wound around from the large diameter cable grooves 74a to the small diameter cable grooves 73a. At this time, immediately before winding of the closing side cable 23 is completed (when the sliding door 13 is substantially fully closed), the closing side cable 23 is wound around a portion of the small diameter cable grooves 73a in which the winding diameter becomes the smallest D3.

Here, the large diameter cable grooves 74a have the same winding diameter D4 throughout the entire region. Thus, even if the closing side cable 23 is wound therearound, the closing side cable 23 is less likely to come off from the large diameter cable grooves 74a. Therefore, a groove pitch P1 of the large diameter cable grooves 74a is packed as much as possible, and thus an increase in dimension of the closing side drum 70 in the axial direction is inhibited. More specifically, partition walls 74b having a thickness dimension of about T1 (approximately 1.0 mm) are provided between the large diameter cable grooves 74a adjacent to each other.

On the other hand, in the small diameter cable grooves 73a, the winding diameter gradually decreases to D1→D2→D3 toward the closing side power transmitting portion 72. For this reason, there may be a problem with the partition walls 74b having the same groove pitch P1 and the same thickness dimension T1 as those of the large diameter cable grooves 74a in that the closing side cable 23 comes off from the small diameter cable grooves 73a as winding of the closing side cable 23 is progressed.

Therefore, in the present embodiment, a groove pitch P2 of the small diameter cable grooves 73a is set to be larger than the groove pitch P1 of the large diameter cable grooves 74a (P2>P1). Thus, relatively thick partition walls 73b having a thickness dimension of T2 (approximately 5.0 mm) are provided between the small diameter cable grooves 73a adjacent to each other (T2>T1).

As a result, rigidity of the partition walls 73b is sufficiently enhanced by thickening the thickness dimension of the partition walls 73b to be T2. Therefore, a height dimension H of the partition walls 73b can be increased (a depth dimension of the small diameter cable grooves 73a can be increased), whereby the closing side cable 23 is also reliably prevented from coming off from the small diameter cable grooves 73a.

Further, as shown in FIG. 4, an inclined portion 61d is provided partially in the drum housing 61 provided around the closing side drum 70 to be inclined along an outer contour of a region where the small diameter portion 73 of the closing side drum 70 is provided. The inclined portion 61d faces tip portions of the partition walls 73b, whereby the closing side cable 23 is also reliably prevented from coming off from the small diameter cable grooves 73a.

As a result, winding of the closing side cable 23 on the closing side drum 70 begins at the large diameter cable grooves 74a, and winding of the closing side cable 23 on the closing side drum 70 ends at the small diameter cable grooves 73a. Therefore, without controlling the rotational speed of the brushless motor 43, it becomes possible to move the sliding door 13 quickly at the beginning of closing and to move the sliding door 13 slowly immediately before the end of closing. That is, a moving speed of the sliding door 13 becomes variable regardless of the control of the brushless motor 43.

The opening side drum 80 constitutes a second drum in the present disclosure, and has a shape as shown in FIGS. 6(a), 6(b) and 8. The opening side drum 80 is formed in a substantially disc shape and is made of a resin material such as plastic, and the through hole 81 on which the pair of small diameter ball bearings B3 (see FIG. 5) are mounted is formed at the rotational center thereof.

An opening side power transmitting portion 82 is provided at one end (the lower side in FIG. 8) of the opening side drum 80 in the axial direction. The opening side power transmitting portion 82 includes an opening side belt engaging portion 82a. The opening side belt engaging portion 82a includes a plurality of irregularities (not shown in detail), and the rubber teeth 91 of the drive belt 90 engage with the opening side belt engaging portion 82a. In addition, since the opening side drum 80 is driven by the closing side drum 70 via the drive belt 90, the opening side drum 80 does not include the engaging claws 72b (see FIG. 7) provided on the closing side drum 70.

The large diameter portion 83 around which the opening side cable 24 is wound is provided on one side of the opening side drum 80 in the axial direction and at a portion on the drum cover 62 side (upper side in FIG. 8) from the opening side power transmitting portion 82. Spiral-shaped large diameter cable grooves 83a are provided in the large diameter portion 83, and a winding diameter of the opening side cable 24 wound around the large diameter cable grooves 83a is constant at d1 substantially equal to an outer diameter dimension of the large diameter portion 83 throughout the entire region of the large diameter cable grooves 83a.

A small diameter portion 84 around which the opening side cable 24 is wound is provided on the other side (the drum cover 62 side) of the opening side drum 80 in the axial direction. The small diameter portion 84 is smaller in diameter than the large diameter portion 83, and spiral-shaped small diameter cable grooves 84a are provided in the small diameter portion 84. In addition, the winding diameter of the opening side cable 24 wound around the small diameter cable grooves 84a gradually decreases to d2→d3→d4 (d2>d3>d4) toward the other side (upper side in FIG. 8) of the opening side drum 80 in the axial direction.

Also, the winding diameter d1 of the large diameter cable grooves 83a is larger than the winding diameter d2 of a portion having the largest diameter in the small diameter cable grooves 84a (d1>d2).

In addition, the large diameter cable grooves 83a are connected to the small diameter cable grooves 84a at a substantially central portion of the opening side drum 80 in the axial direction. That is, the large diameter cable grooves 83a and the small diameter cable grooves 84a form one continuous spiral-shaped cable groove.

An end portion of the opening side cable 24 wound around the opening side drum 80 is fixed to the other side of the opening side drum 80 in the axial direction, that is, the small diameter portion 84 side. That is, as winding of the opening side cable 24 around the opening side drum 80 is progressed, the opening side cable 24 is gradually wound around from the small diameter cable grooves 84a to the large diameter cable grooves 83a. At this time, immediately before winding of the opening side cable 24 is completed (when the sliding door 13 is substantially fully open), the opening side cable 24 is wound around a portion of the large diameter cable grooves 83a where the winding diameter becomes the largest d1.

Here, the large diameter cable grooves 83a have the same winding diameter d1 throughout the entire region. Thus, even if the opening side cable 24 is wound therearound, the opening side cable 24 is less likely to come off from the large diameter cable grooves 83a. Therefore, a groove pitch p1 of the large diameter cable grooves 83a is packed as much as possible, and thus an increase in dimension of the opening side drum 80 in the axial direction is inhibited. More specifically, partition walls 83b having a thickness dimension of about t1 (approximately 1.0 mm) are provided between the large diameter cable grooves 83a adjacent to each other.

On the other hand, in the small diameter cable grooves 84a, the winding diameter gradually decreases to d2→d3→d4 toward the other side of the opening side drum 80 in the axial direction. For this reason, there may be a problem with the partition walls 83b having the same groove pitch p1 and the same thickness dimension t1 as those of the large diameter cable grooves 83a in that the opening side cable 24 comes off from the small diameter cable grooves 84a as winding of the opening side cable 24 is progressed.

Therefore, in the present embodiment, a groove pitch p2 of the small diameter cable grooves 84a is set to be larger than the groove pitch p1 of the large diameter cable grooves 83a (p2>p1). Thus, relatively thick partition walls 84b having a thickness dimension of t2 (approximately 5.0 mm) are provided between the small diameter cable grooves 84a (t2>t1) adjacent to each other.

As a result, rigidity of the partition walls 84b is sufficiently enhanced by thickening the thickness dimension of the partition walls 84b to be t2. Therefore, it becomes possible to increase a height dimension h of the partition walls 84b (increase a depth dimension of the small diameter cable grooves 84a), whereby the opening side cable 24 is also reliably prevented from coming off from the small diameter cable grooves 84a.

Further, as shown in FIG. 5, an inclined portion 62c is provided partially in the drum cover 62 provided to cover the opening side drum 80 to be inclined along an outer contour of a region where the small diameter portion 84 of the opening side drum 80 is provided. The inclined portion 62c faces tip portions of the partition walls 84b, whereby the opening side cable 24 is also reliably prevented from coming off from the small diameter cable grooves 84a.

As shown in shaded portions of FIG. 6(a) and FIG. 6(b), the drive belt (power transmission member) 90 which transmits a driving force of the closing side drum 70 to the opening side drum 80 is provided between the closing side drum 70 and the opening side drum 80. The drive belt 90 is formed in an annular shape and is made of an elastic material having flexibility such as natural rubber, and a plurality of rubber teeth 91 engaged with both of the closing side belt engaging portion 72a and the opening side belt engaging portion 82a are integrally provided inside the drive belt 90.

Here, although not shown in the figure, a reinforcing member (for example, glass fiber, carbon fiber, etc.) which prevents the drive belt 90 from being stretched at the time of a high load is embedded inside the drive belt 90. As a result, the driving force of the closing side drum 70 is efficiently transmitted to the opening side drum 80, and thus occurrence of a rotational difference between the closing side drum 70 and the opening side drum 80 is prevented.

Also, the drive belt 90 has a function as a timing belt which adjusts rotational timings of the closing side drum 70 and the opening side drum 80.

Specifically, the opening side cable 24 (see FIG. 3) is wound around the small diameter cable grooves 84a (see FIG. 8) in the small diameter portion 84 of the opening side drum 80 (state A) at a timing when the closing side cable 23 (see FIG. 3) is wound around the small diameter cable grooves 73a (see FIG. 7) in the small diameter portion 73 of the closing side drum 70. In the “state A,” the sliding door 13 moves, from a predetermined position relative to the opening portion 12, that is, approximately a central portion of a path between the fully closed position and the fully open position of the sliding door 13, to a position where the opening portion 12 is fully closed.

On the other hand, the closing side cable 23 is wound around the large diameter cable grooves 74a (see FIG. 7) in the large diameter portion 74 of the closing side drum 70 (state B) at a timing when the opening side cable 24 is wound around the large diameter cable grooves 83a (see FIG. 8) in the large diameter portion 83 of the opening side drum 80. In the “state B,” the sliding door 13 moves, from a predetermined position relative to the opening portion 12, that is, approximately a central portion of the path between the fully closed position and the fully open position of the sliding door 13, to a position where the opening portion 12 is fully open.

Next, operations of the drive unit 30 formed as described above will be described in detail with reference to the drawings.

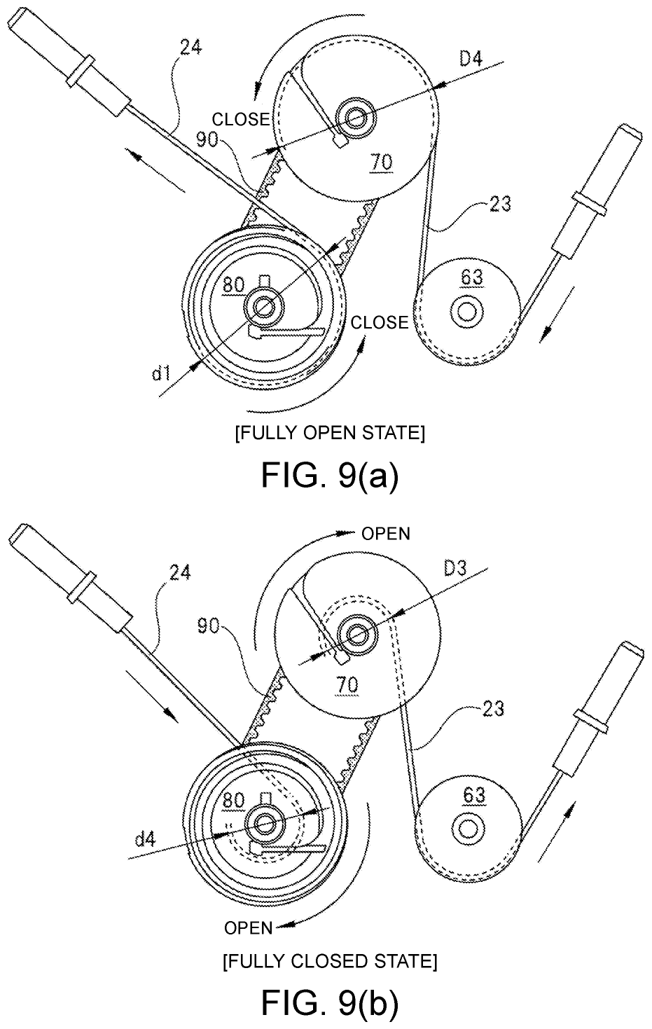

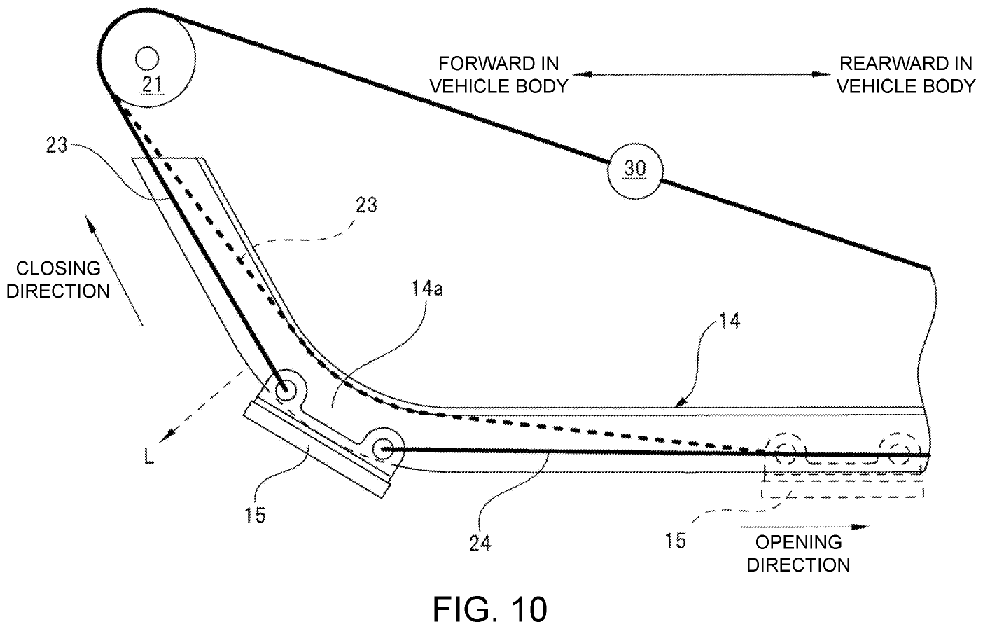

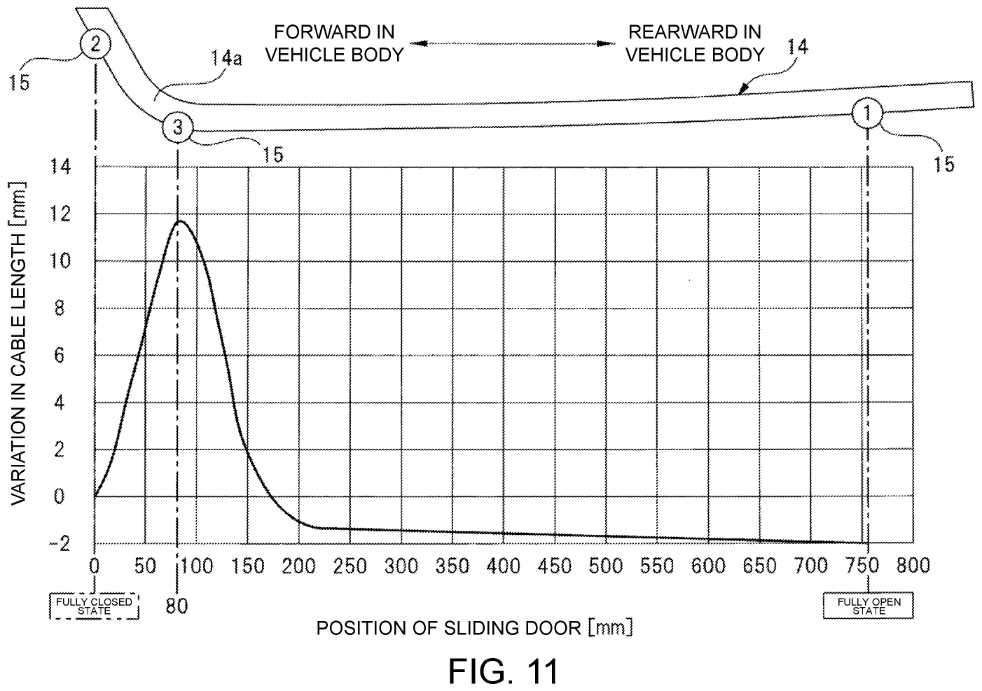

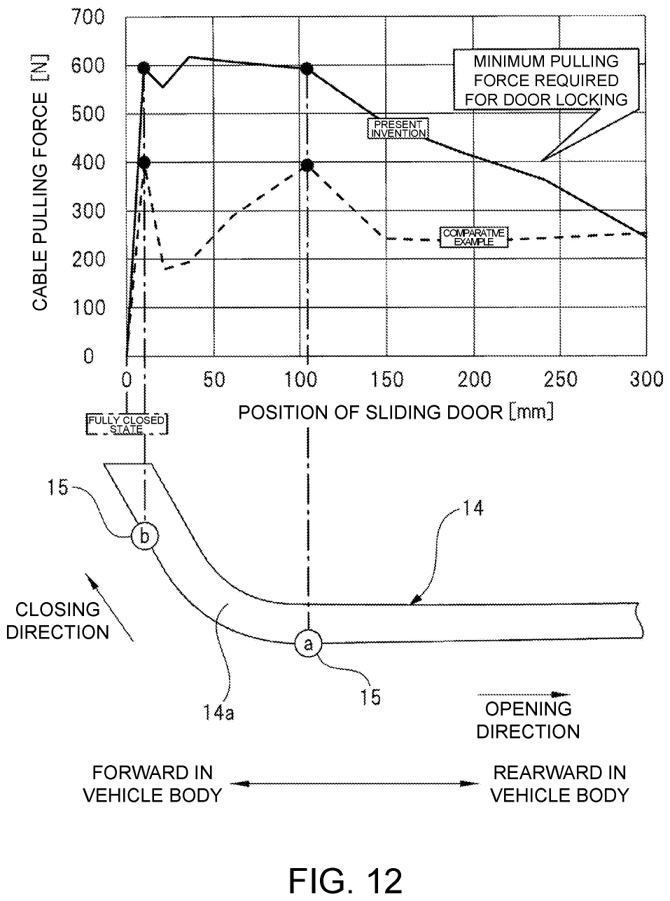

FIG. 9(a) is a view showing the “fully open state” in which the opening side cable is wound around the opening side drum, FIG. 9(b) is a view showing the “fully closed state” in which the closing side cable is wound around the closing side drum, FIG. 10 is an explanatory view illustrating a change in length of the cables, FIG. 11 is a graph illustrating a change in length of the cables, and FIG. 12 is a graph illustrating a door closer function.

[In the Case of Closing the Sliding Door]

First, an operation when the sliding door 13 is closed from a state shown by a solid line in FIG. 2, that is, the fully open state in which the sliding door 13 is fully open will be described.

When an operation switch (not shown) is operated by an operator to execute a “closing operation,” the brushless motor 43 (see FIG. 4) is driven to rotate forward. Then, as shown in FIG. 9(a), the closing side drum 70 is driven to rotate in the direction of an arrow “close” with a large rotational torque via the planetary gear reducer 100 (see FIG. 4). Thus, winding of the closing side cable 23 is gradually progressed from the large diameter cable grooves 74a to the small diameter cable grooves 73a of the closing side drum 70 (see FIG. 7). Therefore, the roller assembly 15 is pulled forward in the vehicle body, and the sliding door 13 moves in the closing direction.

At this time, the opening side cable 24 is gradually released out from a state of being wound around both of the small diameter cable grooves 84a and the large diameter cable grooves 83a (see FIG. 8) of the opening side drum 80. Specifically, the opening side drum 80 is driven to rotate in the direction of the arrow “close” via the drive belt 90 as the closing side drum 70 rotates. Thus, the opening side cable 24 is released to the outside of the drum housing 61 (see FIG. 3) by the roller assembly 15 being pulled and the opening side drum 80 being driven to rotate. At this time, the opening side cable 24 is released out ahead from the large diameter cable grooves 83a of the opening side drum 80, and is subsequently released out from the small diameter cable grooves 84a.

Here, when the closing side cable 23 is wound from the large diameter cable grooves 74a over the small diameter cable grooves 73a of the closing side drum 70, the opening side cable 24 is released out ahead from the large diameter cable grooves 83a of the opening side drum 80, and is subsequently released out from the small diameter cable grooves 84a. Thus, a total length (a cable length) of the cables 23 and 24 pulled out of the drum housing 61 is maintained substantially constant. Therefore, the cables 23 and 24 do not slack, and rattling of the sliding door 13 or the like is effectively inhibited.

As a result, since a change in the cable length of the closing side cable 23 and the opening side cable 24 is inhibited during operation of the drive unit 30, a “tensioner mechanism” which is a relatively large component is omitted in the drive unit 30. Also, as shown in FIG. 3, although the coil springs SP are provided on the closing side cable guide portion 64 and the opening side cable guide portion 65, respectively, these coil springs SP are for removing minute slacks of the pair of cables 23 and 24 which have been stretched due to changes with the elapse of time, and are components which are sufficiently smaller than the “tensioner mechanism” mentioned above.

Here, the sliding door 13 is configured to be pulled into the vehicle body 11 just before the fully closed state thereof (see FIG. 2). Therefore, the roller assembly 15 for moving the sliding door 13 passes through the curved portion 14a of the guide rail 14, as shown in FIG. 10. At this time, since the roller assembly 15 passes through the most outer portion of the curved portion 14a in the radial direction, in particular, the closing side cable 23 is pulled toward the outside of the curved portion 14a in the radial direction, as indicated by a broken arrow L. That is, the closing side cable 23 is largely pulled out of the drum housing 61 when the sliding door 13 (roller assembly 15) is near the fully closed position (a solid line in the figure), as compared with a case in which the sliding door 13 (roller assembly 15) is near the fully open position (a dotted line in the figure).

Specifically, as shown in FIG. 11, a variation in the cable length when the sliding door 13 is in the “fully open state,” that is, when the roller assembly 15 is at a position “1” of the guide rail 14 (a rear side of the vehicle body) is −2 mm. Also, a variation in the cable length when the sliding door 13 is in the “fully closed state,” that is, when the roller assembly 15 is at a position “2” of the guide rail 14 (a front side in the vehicle body) is 0 mm. Therefore, such an extent of the variation (−2 mm) in the cable length when the sliding door 13 is in the “fully open state” can be sufficiently absorbed due to the function of the coil springs SP.

On the other hand, the variation in the cable length when the sliding door 13 is near the fully closed position and at a position of the vehicle body about 80 mm rearward from the “fully closed state,” that is, when the roller assembly 15 is at the position “3” of the guide rail 14 (at the position of the curved portion 14a) becomes about 12 mm, which is the largest. Since the change in the cable length of the closing side cable 23 at this time is relatively large, it cannot be absorbed only with the function of the coil spring SP provided in the closing side cable guide portion 64. Therefore, the winding diameters of the small diameter portion 73 of the closing side drum 70 are set to be as small as shown by D2 and D3 (see FIG. 7), so that the change in the cable length is absorbed by the portion.

More specifically, the winding diameters D2 and D3 of the small diameter portion 73 of the closing side drum 70 are set to be smaller than the winding diameters d3 and d4 (see FIG. 8) of the small diameter portion 84 of the opening side drum 80 (D2<d3, D3<d4). On the other hand, the winding diameter D4 of the large diameter portion 74 of the closing side drum 70 is set to be substantially the same size as the winding diameter d1 of the large diameter portion 83 of the opening side drum 80 (D4≈d1).

As a result, a relatively large change in the cable length (about 12 mm) when the roller assembly 15 passes through the curved portion 14a of the guide rail 14 can be absorbed. Therefore, even if the aforementioned “tensioner mechanism” is not specially provided, problems of an increased resistance making the operation of the drive unit 30 dull or rattling of the sliding door 13 when the sliding door 13 is moving near the fully closed position can be effectively inhibited.

Thereafter, with the continuous closing operation of the drive unit 30, the sliding door 13 is further pulled into the vehicle body 11. Also, finally, a door locker (not shown) provided on the sliding door 13 and a door striker (not shown) provided on the vehicle body 11 are engaged to be a locked state, whereby the sliding door 13 is completely closed to be in the “fully closed state.” Thus, in addition to the function of opening and closing the sliding door 13, the drive unit 30 according to the present embodiment also has the door closer function of locking the sliding door 13 in the fully closed state.

Here, as shown in FIG. 12, when the sliding door 13 is moved near the fully closed position, the drive unit 30 is configured to generate a relatively large cable pulling force [N]. Also, a broken line graph in FIG. 12 shows characteristics of a drive unit (not shown) of a comparative example. In addition, the drive unit of the comparative example adopts a drum in which winding diameters of the cable are the same size in the entire region (a drum in which the winding diameter of the cable does not change).

As shown by a solid line graph in FIG. 12 (in the present disclosure), when the roller assembly 15 moves on the guide rail 14 to be at the position “a” approaching the curved portion 14a, a cable pulling force as large as about 600 N is generated in the present disclosure. This is due to the fact that the winding diameter of the small diameter portion 73 in the closing side drum 70 is set to be as small as D2 and D3 (see FIG. 7).

Here, a movement resistance further increases when the roller assembly 15 passes through the curved portion 14a than when passing through a straight portion of the guide rail 14. In the present disclosure, since the closing side cable 23 is pulled with a large cable pulling force (about 600 N), the sliding door 13 can be smoothly moved just before the sliding door 13 is fully closed. On the other hand, in the comparative example, the cable is pulled with a cable pulling force of about 400 N, which is smaller than that of the present disclosure, there is a possibility that a smooth movement of the sliding door may be hindered just before the sliding door is fully closed.

In addition, when the roller assembly 15 moves on the guide rail 14 and is at position “b” after passing the curved portion 14a, that is, when the sliding door 13 is at a position to be in the locked state (a state in which the door locker and the door striker are engaged), a cable pulling force as large as about 600 N is also generated in the present disclosure. This is, as described above, due to the fact that the winding diameter of the small diameter portion 73 in the closing side drum 70 is set to be as small as D2 and D3 (see FIG. 7).

Therefore, the drive unit 30 of the present disclosure also has the door closer function that requires a large driving force, and thus it is unnecessary to separately provide a door closer device in the vehicle body 11. On the other hand, in the comparative example, when the sliding door is at a position to be in the locked state, the cable can be pulled only with a cable pulling force of about 400 N which is smaller than that of the present disclosure. Therefore, in the comparative example, there is no room for the pulling force for allowing the sliding door to be in the locked state, and the function as a door closer cannot be achieved. Also, in order to fully exhibit the door closer function, it is necessary to devise a method by which a cable pulling force of at least 400 N can be stably output.

Further, in the drive unit 30 of the present disclosure, although the cable pulling force of the closing side cable 23 is increased to about 600 N, this is also due to the fact that the brushless motor 43 is disposed coaxially with the closing side drum 70 required to be driven with a high torque (see FIG. 4), and the driving torque of the brushless motor 43 can be transmitted to the closing side drum 70 with high accuracy, as described above.

[In the Case of Opening the Sliding Door]

When the operating switch is operated by the operator to execute an “opening operation,” the brushless motor 43 is driven to rotate in reverse. Then, as shown in FIG. 9(b), the opening side drum 80 is driven to rotate in the direction of an arrow “open” via the drive belt 90. Thus, winding of the opening side cable 24 is gradually progressed from the small diameter cable grooves 84a to the large diameter cable grooves 83a (see FIG. 8) of the opening side drum 80. Therefore, the roller assembly 15 (see FIG. 2) is pulled rearward in the vehicle body, and the sliding door 13 moves in the opening direction.

At this time, the closing side cable 23 is gradually released out from a state of being wound around both of the small diameter cable grooves 73a and the large diameter cable grooves 74a (see FIG. 8) of the closing side drum 70. Specifically, the closing side drum 70 is driven to rotate in the direction of the arrow “open,” and thus the closing side cable 23 is released to the outside of the drum housing 61 by pulling the roller assembly 15 and driving the closing side drum 70 to rotate. At this time, the closing side cable 23 is released out ahead from the small diameter cable grooves 73a of the closing side drum 70, and is subsequently released out from the large diameter cable grooves 74a.

As described above, in the case of opening the sliding door 13, a reverse operation is followed, as compared to the “case of closing the sliding door” described above. In addition, in the case of opening the sliding door 13, a large cable pulling force is not required, as compared to the case of closing and locking the sliding door 13. Therefore, even with a driving torque for the opening side drum 80 transmitted via the drive belt 90, the sliding door 13 can be sufficiently opened without the drive belt 90 being stretched or come off.

As described above, the drive unit 30 according to the present embodiment is configured such that the closing side drum 70 and the opening side drum 80 are provided parallel to each other, and the closing side drum 70 is driven by the brushless motor 43, and the driving force of the closing side drum 70 is transmitted to the opening side drum 80 via the drive belt 90. Also, the drive unit 30 is configured such that, in the state where the closing side cable 23 is wound around the small diameter portion 73 of the closing side drum 70 and the opening side cable 24 is wound around the small diameter portion 84 of the opening side drum 80, the sliding door 13 moves from the predetermined position relative to the opening portion 12 to the position where the opening portion 12 is fully closed, and, in the state where the closing side cable 23 is wound around the large diameter portion 74 of the closing side drum 70 and the opening side cable 24 is wound around the large diameter portion 83 of the opening side drum 80, the sliding door 13 moves from the predetermined position relative to the opening portion 12 to the position where the opening portion 12 is fully open.

As a result, an increase in the thickness dimension of the drive unit 30 in the axial direction of the closing side drum 70 and the opening side drum 80 can be inhibited. In addition, in particular, a change in the cable length of the closing side cable 23 can be absorbed while the door closer function is imparted to the drive unit 30. Further, since the brushless motor 43 is provided coaxially with the closing side drum 70 required to be driven with a high torque, the driving torque of the brushless motor 43 can be efficiently transmitted to the closing side drum 70.

Also, according to the drive unit 30 of the present embodiment, the planetary gear reducer 100 which reduces the rotational speed of the brushless motor 43 to increase the rotational torque of the closing side drum 70 is provided between the brushless motor 43 and the closing side drum 70.

As a result, since the brushless motor 43 can be made thinner and miniaturized, and the dimension of the planetary gear reducer 100 itself in the axial direction can be made thinner, it is possible to make the drive unit 30 thinner (miniaturized).

It goes without saying that the present disclosure is not limited to the above embodiments, and various modifications can be made without departing from the scope of the disclosure. For example, in the above embodiment, the example in which the three-phase brushless motor 43 is adopted as the electric motor has been described, but the present disclosure is not limited thereto, and an electric motor with another specification such as a brushed electric motor may be adopted.

Also, in the above embodiment, although the example in which the drive belt 90 made of natural rubber or the like is adopted as the power transmission member has been described, the present disclosure is not limited thereto, and a power transmission member with another specification such as a metal chain may also be provided between the closing side drum 70 and the opening side drum 80.

In addition, materials, shapes, dimensions, numbers, dispositional places and the like of the respective components in the above embodiments are arbitrary as long as the present disclosure can be achieved, and the present disclosure is not limited to the above embodiments.

What is claimed is:

1. A drive unit which drives an opening and closing body for opening and closing an opening portion, comprising:
a first axle and a second axle which are provided parallel to each other;
a first drum which is rotatably provided on the first axle and has a small diameter portion on one side in an axial direction thereof and a large diameter portion on the other side in the axial direction;
a second drum which is rotatably provided on the second axle and has a large diameter portion on one side in an axial direction thereof and a small diameter portion on the other side in the axial direction;
a first cable which pulls the opening and closing body in a closing direction;
a second cable which pulls the opening and closing body in an opening direction;
an electric motor which is provided coaxially with the first axle and drives the first drum; and
a power transmission member which is provided between the first drum and the second drum and transmits a driving force of the first drum to the second drum,
wherein, in a state in which the first cable is wound around the small diameter portion of the first drum and the second cable is wound around the small diameter portion of the second drum, the opening and closing body moves from a predetermined position relative to the opening portion to a position where the opening portion is fully closed, and
in a state in which the first cable is wound around the large diameter portion of the first drum and the second cable is wound around the large diameter portion of the second drum, the opening and closing body moves from the predetermined position relative to the opening portion to a position where the opening portion is fully open.

2. The drive unit according to claim 1, wherein a reduction mechanism is provided between the electric motor and the first drum, and the reduction mechanism reduces a rotational speed of the electric motor to increase a rotational torque of the first drum.
